(19) United States
(12) Patent Application Publication
(10) Pub. No.: US 2017/0287008 A1
(43) Pub. Date: Oct. 5, 2017

(54) Method and Electronic Device for Promoting Website Traffic of a Website by Regularly Replacing Webpage Skins

(71) Applicants: Le Holdings (Beijing) Co., Ltd., Beijing (CN); Lemall (Beijing) Co., Ltd., Beijing (CN)

(72) Inventors: Tianxiang Zheng, Beijing (CN); Yu Bai, Beijing (CN)

(21) Appl. No.: 15/245,723

(22) Filed: Aug. 24, 2016

Related U.S. Application Data
(63) Continuation of application No. PCT/CN2016/089777, filed on Jul. 12, 2016.

(30) Foreign Application Priority Data
Mar. 30, 2016 (CN) 2016101923963

(51) Int. Cl. G06Q 30/02; G06Q 30/06; H04L 29/08

(52) U.S. Cl. CPC G06Q 30/0264; H04L 67/02; G06Q 30/0643

(57) ABSTRACT

The present disclosure discloses a method and an apparatus for promoting website traffic of a website by regularly replacing webpage skins. The webpage belongs to a shopping website. The method for promoting website traffic of a website by regularly replacing webpage skins includes the following steps: pre-storing a plurality of different skins associated with products of the shopping website; setting a replacement time point and a display period of each skin; and replacing the webpage skin of the shopping website at each replacement time point, wherein the skin has links of the products associated with the shopping website provided at a plurality of different positions. According to the present disclosure, the website traffic and revenue of the website are improved.

### CROSS REFERENCE TO RELATED APPLICATIONS

This disclosure is a continuation of International Application No. PCT/CN2016/089777, filed Jul. 12, 2016, and claims priority to Chinese Patent Application No. 201610192396.3, filed Mar. 30, 2016, the disclosures of which are hereby incorporated in their entirety by reference.

### TECHNICAL FIELD

The present disclosure relates to the webpage technologies, and particularly relates to a method and electronic device for promoting website traffic of a website by regularly replacing webpage skins.

### BACKGROUND

With the rapid development of the Internet, more and more people choose to shop online; not only the time of window-shopping is saved, but also the trouble of in-store shopping comparison is avoided. Besides, with the advent of smart mobile terminals and the complete coverage of 4G networks, the network speed does not constitute any bottleneck for limiting shopping consumption of the mobile terminals. Meanwhile, with the advent of a large number of mobile phone payment platforms such as Alipay etc., mass migration of the online shopping people from the PC platforms to the mobile terminals is really promoted.

With the rapid development of webpage processing technologies, a website may set the skins of the webpage browsed by users according to the user demands or the merchant requirements. Meanwhile, the website may also provide push service of Internet specific information. By means of presetting the specific information associated with webpage content, the specific information may be displayed on the webpage browsed by a user when the user browses the webpage.

At present, in order to promote the sales of a certain type of products in a shopping website, the sales promotion information or advertising words of the products is generally provided in a blank position; the advertising effect is limited; many users cannot be aware of the advertisement during browsing the shopping website; the purchase desire of the users cannot be promoted to a great extent; the website traffic of the products in the website is reduced; the revenue of the website is influenced.

The information disclosed in the Background section only aims to improve the understanding of the overall background of the present disclosure and should not admit or imply in any form that the information constitutes the prior art which has already been known to those of ordinary skill in the art.

### SUMMARY

The present disclosure aims to provide a method and a device for promoting website traffic of a website by regularly replacing webpage skins, which are capable of advertising and promoting the products in a way of eye-catching, improving the click rate and the purchase desire of the website access users and increasing the website traffic and the revenue of the website.

In one aspect, the present disclosure provides a method for promoting website traffic of a website by regularly replacing webpage skins and the webpage belongs to a shopping website. The method includes the following steps: pre-storing a plurality of different skins associated with the products that are being sold on the shopping website; setting a replacement time point and a display period of each skin; and replacing the webpage skin of the shopping website at each replacement time point, where the skin has links of the products associated with the shopping website and the links are provided at a plurality of different positions.

In another aspect, the present disclosure provides an electronic device. The electronic device includes: at least one processor; and a memory communicably connected with the at least one processor for storing instructions executable by the at least one processor. Execution of the instructions by the at least one processor causes the at least one processor to: pre-store a plurality of different skins associated with products that are being sold on the shopping website; set a replacement time point and a display period for each skin; and replace the webpage skin of the shopping website at said replacement time point. The skin has links of the products that are being sold on the shopping website, and said links are provided at different positions of the webpage.

In yet another aspect, the present disclosure provides a non-transitory computer-readable storage medium that stores executable instructions. When executed by an electronic device, the executable instructions cause the electronic device to: pre-store a plurality of different skins associated with products that are being sold on the shopping website; set a replacement time point and a display period for each skin; and replace the webpage skin of the shopping website at said replacement time point. The skin has links of the products that are being sold on the shopping website, and said links are provided at different positions of the webpage.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for promoting website traffic of a website by regularly replacing webpage skins according to the present disclosure.

FIG. 2 is a schematic diagram of an apparatus for promoting website traffic of a website by regularly replacing webpage skins according to the present disclosure.

FIG. 3 is a structural block diagram of an electronic device for implementing the method for promoting website traffic of a website by regularly replacing webpage skins according to the present disclosure.

### DETAILED DESCRIPTION

The specific embodiments of the present disclosure will be described below in detail with reference to the drawings, but it should be understood that the protection scope of the present disclosure is not limited by the specific embodiments.

Unless otherwise clearly shown, the terms “including” or variations thereof, such as “comprising” or “having” should be understood as including described components or constituent parts and not excluding other components or other constituent parts.

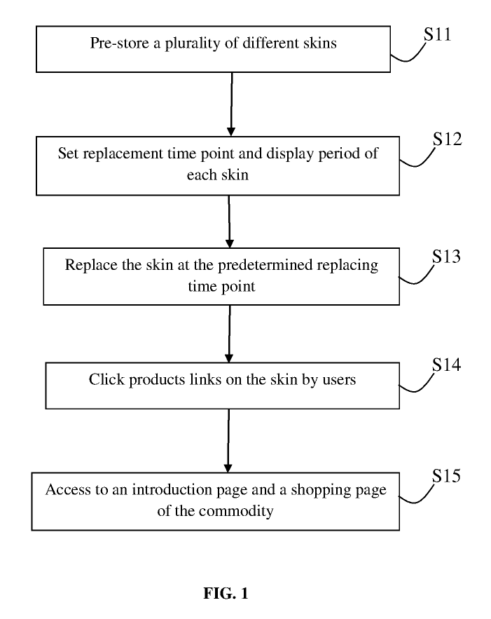

FIG. 1 is a flow chart showing a method for promoting website traffic of a website by regularly replacing webpage skins according to the present disclosure. As shown in FIG. 1, according to a method for promoting website traffic of a website by regularly replacing webpage skins according to preferred implementation of the present disclosure, the webpage belongs to a shopping website, and the method includes the following steps:

At step S11, a plurality of different skins associated with the products of the shopping website is pre-stored in a server of the website. The manners for associating the skin with the products of the shopping website includes one or more of the following: an image of the associated products is provided on the skin, a text introduction of the associated products is provided on the skin, and an advertising poster of the associated products is provided on the skin etc.;

At step S12, a replacement time point and a display period for each skin are set by the server. The display period of the skin maybe any scheduled time, for example, a week, half a month or a month. The replacement time point can be set as 8:00 AM of every Monday, or special holidays and festivals, grand film release dates etc. Preferably, the setting modes are stored in the server in a form of a mapping table, for example as shown in Table 1:

TABLE 1

| | Display | |
|---|---|---|
| Skin Type | Period | Replacement time point |
| Women Dress Sales Promotion | A Week | 8:00 AM, Jan. 1, 2016 |
| Festival | | |
| “Toy Story” Film Shopping Festival | 10 Days | 7:20 AM, Jan. 8, 2016 |
| Mobile Phone Carnival | 15 Days | 17:00 PM, Jan. 18, 2016 |

At step S13, the webpage skin of the shopping website is replaced at a predetermined replacement time point of the system. The skin has links of the products associated with the shopping website. The links are provided at different positions of the webpage. In this way, after a new skin is set on the webpage, a user may click, in the step S14, to enter a product introduction page and a shopping page, and then browse and purchase products in the step S15. It should be understood that step S14 and step S15 are merely for purpose of describing the whole process, and these steps belong to the operation steps of the user, which do not constitute the protection scope of the present disclosure.

In a preferred implementation of the present disclosure, because a webpage which is most commonly used in the shopping website is a website homepage or a website login page, therefore, the webpage with replaced skin can be set as the homepage of the shopping website or the login page of the shopping website; of course, the set of the present disclosure is not limited here; any other webpage can adopt the set of the present disclosure.

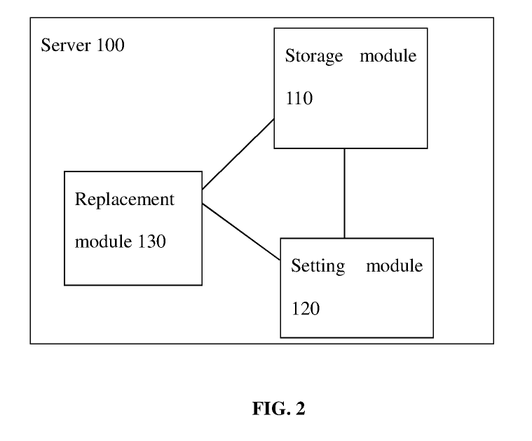

FIG. 2 is a schematic diagram of an apparatus for promoting website traffic of a website by regularly replacing webpage skins according to the present disclosure. As shown in FIG. 2, a server 100 of the shopping website includes a storage module 110 configured for storing a plurality of different skins associated with the products of the shopping website, a setting module 120 associated with the storage module 110 and configured for setting a replacement time point and a display period of each skin, and a replacing module 130 connected with the storage module 110 and the setting module 120 and configured for replacing the webpage skin of the shopping website at each replacement time point.

The functions and working manners of the above-described modules of the apparatus for promoting website traffic of a website by regularly replacing webpage skins according to the present disclosure have been introduced with reference to the FIG. 1 and are not described here again.

The method for promoting website traffic of a website by regularly replacing webpage skins according to the present disclosure overcomes the defect that in the prior art, the advertisements of sales promotion of the products is not eye-catching enough to catch the attention of users. Because the skin occupies the substrate of the whole webpage, the skin is conspicuous and striking enough. The advertising posters or the advertising patterns of the products are set on the skin and the webpage links of the advertised products are set in multiple positions of the skin, so that the users may access to the products purchasing page conveniently, thus the website traffic and the revenue of the website are improved.

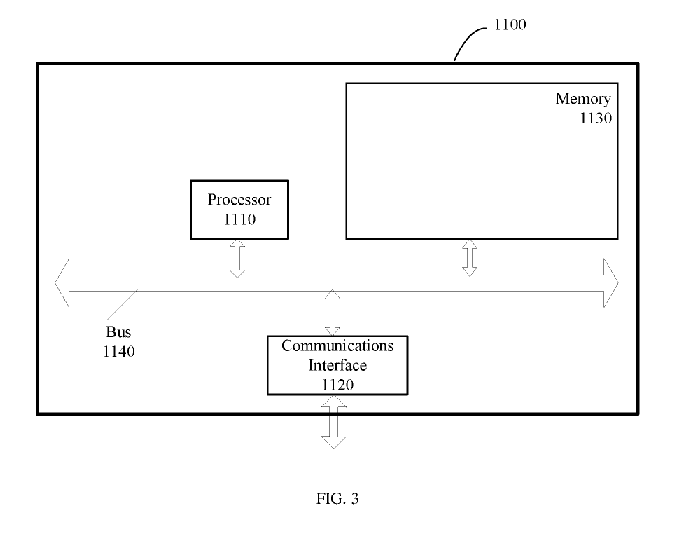

FIG. 3 is a structure block diagram of anelectronic device for implementing the method for promoting website traffic of a website by regularly replacing webpage skins according to the present disclosure. The electronic device 100 maybe a host server, a personal computer (PC), a portable computer or a terminal etc. with computing capability. The specific embodiments of the present disclosure do not limit the concrete implementation of a computing node.

The electronic device 1100 includes a processor 1110, a communications interface 1120, a memory (memory array) 1130 and a bus 1140, where the processor 1110, the communications interface 1120 and the memory 1130 implement intercommunication via the bus 1140.

The communications interface 1120 is configured for communicating with network elements, where the network elements include virtual machine management centers, shared memory etc.

The processor 1110 is configured for executing a program. The processor 1110 maybe a central processing unit CPU or an ASIC (Application Specific Integrated Circuit) or is configured as one or more integrated circuits for implementing the embodiments of the present disclosure.

The memory 1130 is configured for storing files. The memory 1130 may include a high-speed RAM memory and may also include a non-volatile memory, for example, at least one disk memory. The memory 1130 also maybe a memory array. The memory 1130 also may be divided into blocks; and the blocks maybe combined to be a virtual volume according to a certain rule.

In a possible implementation, the above-described program maybe program code including computer operation instructions. Execution of the instructions by the processor causes the processor to: pre-store a plurality of different skins associated with products that are being sold on the shopping website; set a replacement time point and a display period for each skin; and replace the webpage skin of the shopping website at said replacement time point. The skin has links of the products that are being sold on the shopping website, and said links are provided at different positions of the webpage.

In another embodiment of the present disclosure, a non-transitory computer-readable storage medium is provided. The non-transitory computer-readable storage medium stores executable instructions thereon. When executed by an electronic device, the executable instructions cause the electronic device to: pre-store a plurality of different skins associated with products that are being sold on the shopping website; set a replacement time point and a display period for each skin; and replace the webpage skin of the shopping website at said replacement time point. The skin has links of the products that are being sold on the shopping website, and said links are provided at different positions of the webpage.

Those of ordinary skill in the art should understand that an embodiment of the present disclosure may be provided as a method, a system or a computer program product. Therefore, the present disclosure may be in the forms of full hardware embodiments, full software embodiments or embodiments with combination of software and hardware. Moreover, the present disclosure may in the form of a computer program product implemented on one or more computer usable storage medium (including but not limited to the disk memories and optical memories etc.) including computer-available program code.

It should be understood that in the apparatus and/or method of the present disclosure, the steps are successively performed according to an order described in the description; however, as long as the same or equivalent technical effects are achieved, the steps may also be performed in parallel or performed independent of each other.

The above description of specific exemplary implementation solutions of the present disclosure is for the purposes of illustration and description. The description is not intended to limit the present disclosure to the disclosed accurate form; moreover, obviously, a large quantity of variations and changes may be made according to the above teaching. The selection and description of the exemplary embodiments aims at explaining the specific principle and the practical application of the present disclosure, so that those of ordinary skill in the art can implement and use various different exemplary embodiments and various different selections and changes of the present disclosure. The scope of the present disclosure is intended to be limited by claims and equivalent forms thereof.

What is claimed is:

1. A method for promoting website traffic of a website by regularly replacing webpage skins, the webpage belonging to a shopping website, the method comprising:
pre-storing a plurality of different skins associated with products that are being sold on the shopping website;
setting a replacement time point and a display period for each skin; and replacing the webpage skin of the shopping website at said replacement time point;
wherein the skin has links of the products that are being sold on the shopping website, and said links are provided at different positions of the webpage.

2. The method according to claim 1, wherein the association of the skins with the products of the shopping website includes one or more of the following: an image of the associated products is provided on the skin, a text introduction of the associated products is provided on the skin, and an advertising poster of the associated products is provided on the skin.

3. The method according to claim 1, wherein the webpage is a homepage of the shopping website or a login page of the shopping website.

4. The method according to claim 1, wherein the display period of the skin is at least one of the following: a week, two weeks, and a month.

5. An electronic device, comprising:
at least one processor; and
a memory communicably connected with the at least one processor for storing instructions executable by the at least one processor, wherein execution of the instructions by the at least one processor causes the at least one processor to:
pre-store a plurality of different skins associated with products that are being sold on the shopping website;
set a replacement time point and a display period for each skin; and
replace the webpage skin of the shopping website at said replacement time point;
wherein the skin has links of the products that are being sold on the shopping website, and said links are provided at different positions of the webpage.

6. The electronic device according to claim 5, wherein the association of the skins with the products of the shopping website includes one or more of the following: an image of the associated products is provided on the skin, a text introduction of the associated products is provided on the skin, and an advertising poster of the associated products is provided on the skin.

7. The electronic device according to claim 5, wherein the webpage is a homepage of the shopping website or a login page of the shopping website.

8. The electronic device according to claim 5, wherein the display period of the skin is at least one of the following: a week, two weeks, and a month.

9. A non-transitory computer-readable storage medium storing executable instructions thereon, which, when executed by an electronic device, cause the electronic device to:
pre-store a plurality of different skins associated with products that are being sold on the shopping website;
set a replacement time point and a display period for each skin; and
replace the webpage skin of the shopping website at said replacement time point;
wherein the skin has links of the products that are being sold on the shopping website, and said links are provided at different positions of the webpage.
